(19) United States
(12) Patent Application Publication
(10) Pub. No.: US 2010/0070429 A1
(43) Pub. Date: Mar. 18, 2010

(54) Systems And Methods For Investment Tracking

(76) Inventors: Richard B. Spurgin, Amherst, MA (US); Thomas R. Schneeweis, Amherst, MA (US); Hossein B. Kazemi, Florence, MA (US)

Correspondence Address: KILPATRICK STOCKTON LLP, 1001 WEST FOURTH STREET, WINSTON-SALEM, NC, 27101, US

(21) Appl. No.: 12/560,053

(22) Filed: Sep. 15, 2009

Related U.S. Application Data
(60) Provisional application No. 61/097,102, filed on Sep. 15, 2008.

(51) Int. Cl. G06Q 40/00

(52) U.S. Cl. 705/36 R

(57) ABSTRACT

Systems and methods for investment tracking are disclosed. For example, one method for investment tracking includes the steps of receiving information describing a plurality of funds, receiving a selection of a benchmark for an investment portfolio, identifying a candidate set of assets for the investment portfolio, the candidate set of investments comprising a plurality of asset classes; and identifying a set of candidate weighting factors to associate with at least one of the plurality of asset classes. The method further includes the steps of selecting at least one weighting factor from the set of candidate weighting factors, selecting at least one asset class from the plurality of asset classes based on a stepwise procedure and associating the at least one weighting factor with at least one asset class, determining a weight value of the at least one weighting factor; estimating, based on a GARCH analysis, a variance/covariance of asset returns, a variance of the benchmark, a covariance vector of asset returns, and an expected return on an asset; constructing the investment portfolio from at least one of the candidate sets of assets and based on the at least one weighting factor, and purchasing assets corresponding to the investment portfolio.

### CROSS-REFERENCES TO RELATED APPLICATION

This application claims priority to U.S. Provisional Patent Application No. 61/097,102 filed Sep. 15, 2008, entitled “Systems and Methods for investment Tracking,” the entirety of which is hereby incorporated by reference.

### FIELD OF THE INVENTION

The present application generally relates to investment tracking and more specifically relates to tracking investment portfolio allocations.

### BACKGROUND

In financial markets, it is common for an investor to purchase a mix of assets to maintain a diversified investment portfolio to hedge against risk, but still receive a reasonable rate of return. For example, investors may invest money with investment funds that have a focus on a particular type of asset or that track one or more stock market indices. More sophisticated investors with significant assets may also invest with hedge funds to achieve a greater rate of return. However, it may be difficult to select the appropriate mix of assets for an investment portfolio, particularly if the investor desires to invest in funds, such as hedge funds or index funds. Further, it may be difficult to maintain a desired mix of investment assets over time as portions of an investor's holdings change value, which may affect the balance of assets within the portfolio.

### SUMMARY

Embodiments of the present invention provide systems and methods for investment tracking. Another embodiment comprises a computer-readable medium comprising program code for executing such a method.

These illustrative embodiments are mentioned not to limit or define the invention, but to provide examples to aid understanding thereof. Illustrative embodiments are discussed in the Detailed Description, and further description of the invention is provided therein. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying figures, wherein:

FIG. 1 shows a system for investment tracking according to one embodiment of the present invention; and

FIG. 2 shows a method for investment tracking according to one embodiment of the present invention.

### DETAILED DESCRIPTION

Embodiments of the present invention provide systems and methods for investment tracking. For example, in one illustrative embodiment, a system for investment tracking is configured to generate an investment portfolio based on a benchmark rate of return, information about one or more funds to be tracked, and the types of assets to be included within the investment portfolio. Suitable funds may include hedge funds, investable indices, uninvestable indices, and mutual funds. Funds may hold a variety of assets, such as Exchange Traded Funds (ETFs), Exchange Tradeable Notes (ETNs), futures contracts, or other suitable investment vehicles. Such assets may represent investments in tangible or intangible goods, such as real estate, commodities, derivatives, stocks, or bonds. An investment portfolio according to one embodiment of the present invention comprises assets allocated according to an analysis of information about one or more funds.

In general, investments, and investing, are important features of economies and economic systems. Public and private companies may use proceeds (income) from investments for many purposes, including, but not limited to, funding the purchases of capital equipment and/or property, funding construction, to hiring personnel, and/or funding research and development activities. Each purpose ultimately assists a company in producing an item of commerce (e.g. a hard or soft good, pharmaceutical, apparatus, commodity, etc.) or delivering a service. Thus, investments are useful, necessary and linked to the production of items of commerce and delivery of services in today's economy.

In this illustrative embodiment, the system comprises a computer in communication with a network for receiving asset and fund information. The system receives information describing one or more funds, such as investment allocation, investment strategy, and historical fund performance, from the network through a network interface. After receiving the fund information, the system receives a selection of a benchmark for the performance of the investment portfolio to be created. The system then identifies a candidate set of asset classes for the portfolio from a set of available asset classes. Suitable asset classes may include ETFs, ETNs, or futures contracts (e.g. a commodities future). The system may identify suitable asset classes by identifying asset classes that have a minimum track record or that have a minimum share price greater than an acceptable threshold. After identifying the candidate set of asset classes, the system determines one or more weighting factors to use when constructing the investment portfolio. A weighting factor in this illustrative embodiment may affect the percentage of the portfolio made up by a particular asset class.

After determining the weighting factors to use, the system selects one or more asset classes from the candidate set of asset classes to include within the investment portfolio based on a GARCH analysis. After the weighting factors and asset classes have been determined, the system constructs the investment portfolio from the asset classes based on the weighting factors. Once the portfolio is selected, the system purchases the assets and adjusts the leverage of the portfolio based at least in part on the volatility of the markets for the assets.

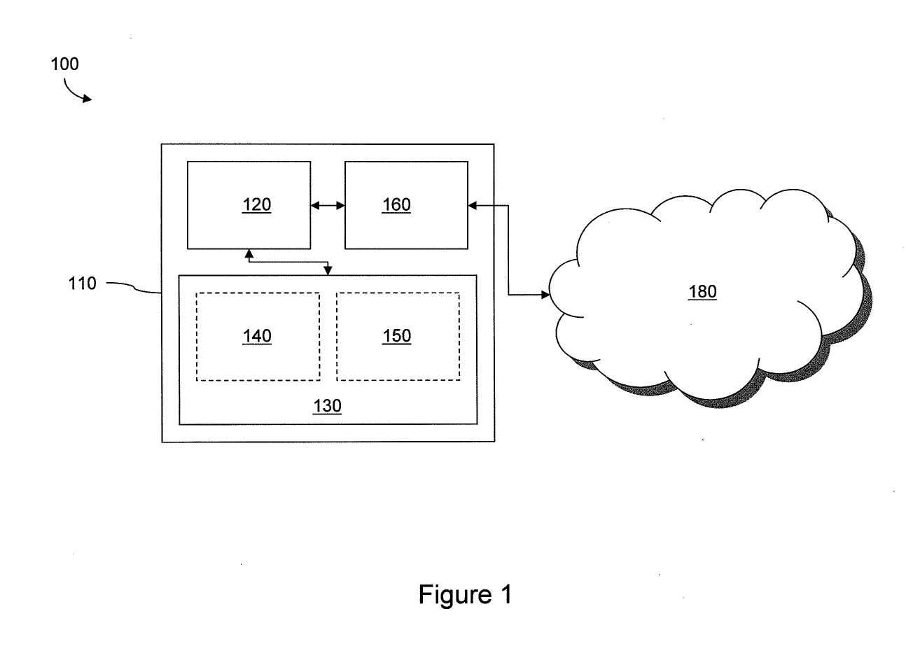

Referring now to the figures in which like numbers refer to like elements throughout the several drawings, FIG. 1 shows a system 100 for investment tracking according to one embodiment of the present invention. The system 100 comprises a computer 110 having a processor 120, a memory 130, and an interface device 160. The processor 120 is in communication with the memory 130 and the interface device 160. The memory 130 comprises program code 140 for performing a method for investment tracking according to one embodiment of the present invention. In addition, the memory 130 comprises information 150 describing one or more funds, such as return and volume data, track record information, average daily volume for the previous month, the most recent price, or dollar value of average daily volume. The processor 120 is configured to execute the application 140 stored within the memory 130 and to access and use the information 150 stored within the memory 130.

In the embodiment shown in FIG. 1, the processor is configured to receive information about a plurality of funds from the interface device 160. The interface device 160 comprises a network interface device, such as an Ethernet interface device. The interface device 160 is in communication with network 180 and is configured to receive information about the plurality of funds from the network and to send the information to the processor 120, which is configured to store the information in memory. In some embodiments, the interface device 160 comprises a wireless interface device 160, such as an 802.11 interface device, a WiFi interface device, or a cellular interface device. In other embodiments, the interface device may comprise a user interface device, such as a keyboard or a mouse for manual entry of information about a plurality of funds.

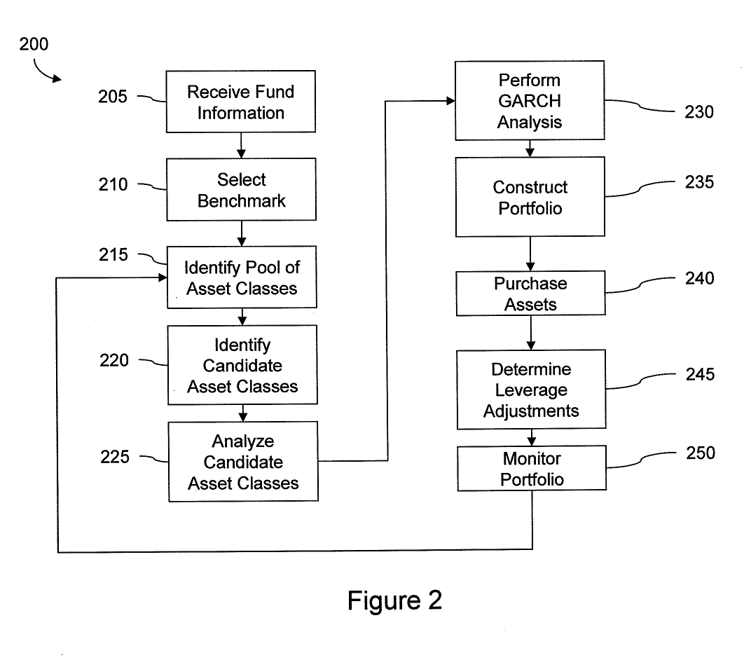

Referring now to FIG. 2, FIG. 2 shows a method for investment tracking according to one embodiment of the present invention. The method 200 shown in FIG. 2 will be described with reference to the system shown in FIG. 1.

The method 200 begins in step 205 by receiving information about a plurality of funds. For example, in one embodiment, the processor 120 is configured to receive information about a plurality of funds from the interface device 160. For example, the interface device 160 may access stock exchange information or commodity exchange information using the network 180. The interface device 160 provides the received information to the processor 120, which may then store the received information in memory 130. After receiving information about a plurality of funds, the method proceeds to step 210.

In step 210, a benchmark is selected. A benchmark may comprise a desired return for a diversified portfolio based on one or more hedge fund managers. For example, in one embodiment, the processor 120 may select a benchmark based at least in part on a publicly available uninvestable index, such as those produced by Credit Agricol Structured Asset Management (e.g. CASAM-CISDM), HFR Asset Management, and/or others. In some embodiments, the processor 120 may select a benchmark based at least in part on a publicly available investable index, such as a Dow Jones index, an HFR index, and/or others. Further, some embodiments may employ one or more filters to select a benchmark.

In an embodiment employing one or more filters, the processor 120 may filter data associated with one or more hedge fund managers, such as data from publicly available information reported by hedge fund managers, to identify a benchmark. In such an embodiment, a first filter includes determining a strategy employed by a hedge fund manager. For example, processor 120 may determine the strategy by using the strategy declared by the hedge fund manager, or by using one or more statistical methods, such as a Sharpe-Style analysis or Cluster analysis. In the embodiment shown in FIG. 1, the processor determines the hedge fund manager's strategy based on the publicly-declared strategy of the hedge fund manager.

Some embodiments may apply additional or alternative filters. For example, in one embodiment of the present invention, the processor 120 employs a second filter to select hedge fund managers having a minimum track record. For example, the second filter may identify hedge fund managers that have at least a three-year track record. In addition to the second filter, the processor 120 may apply a third filter to select only hedge fund managers having an investment success between the top 1% of a sample of hedge fund managers and the bottom 25% of a sample of hedge fund managers. The processor 120 may employ still further, or alternative, filters, such as filters based on the size of assets managed by a hedge fund manager, the volatility of assets managed by a hedge fund manager, and/or factor exposures to hedge fund managers.

In embodiments using a custom benchmark, the processor 120 may be able to take advantage of the presence of persistence in the performance of hedge fund managers. Academic and industry research has shown that some hedge fund managers display persistence in their performance on a quarterly basis. That is, previous quarter's winners/losers are likely to repeat as winners/losers during the following quarter. Furthermore, this persistence is usually stronger in the case of underperforming funds. Therefore, the processor 120 may rebalance the benchmark, such as on a quarterly basis, in a way that it would assign lower weights to underperforming funds. Such an embodiment may outperform an index that gives equal weights to all funds. Therefore, embodiments of the present invention may be adjusted to track a rebalanced portfolio and may display improved performance.

Once a benchmark is selected, the method proceeds to step 215. In step 215, the processor 120 identifies a potential set of asset classes for the portfolio. In general, the assets selected for the portfolio may be selected from any number of asset types. For example, in the embodiment shown in FIG. 2, the assets primarily comprised ETFs, Exchange Traded Notes, and futures contracts selected from the following pools of assets:

| Large Cap | | | IShares DJ | | | |
|---|---|---|---|---|---|---|
| US. Equities | IShares | IShares | US | S&P 500 | S&P 500 | S&P 500 |
| Dec. 1, 2007 to | Russell 1000 | Russell 1000 | Transportation | Materials | Energy | Financial |
| May 31 2008 | Value Index | Growth Index | Average | Sector | Sector | Sector |
| Average daily return | −0.036% | −0.014% | 0.136% | 0.079% | 0.145% | −0.132% |
| Daily return standard | 1.33% | 1.20% | 1.79% | 1.93% | 1.96% | 2.37% |
| deviation | | | | | | |
| Annualized daily | 21.1% | 19.0% | 28.3% | 30.5% | 31.0% | 37.5% |
| return stdev | | | | | | |
| Average daily volume | 2,547,424 | 3,603,263 | 1,457,939 | 13,004,900 | 23,901,439 | 114,682,422 |
| Maximum daily volume | 7,376,421 | 8,891,171 | 4,488,994 | 33,544,464 | 56,100,348 | 279,198,419 |
| Minimum daily volume | 779,057 | 1,374,776 | 70,000 | 1,318,270 | 10,490,694 | 23.566,267 |
| High price | 82.83 | 62.57 | 97.26 | 46.03 | 90.39 | 31.32 |
| Low price | 69.99 | 52.75 | 73.95 | 36.82 | 66.76 | 23.26 |

| Large Cap | | | S&P 500 | | | S&P 500 |
|---|---|---|---|---|---|---|
| US. Equities | S&P 500 | S&P 500 | Consumer | | S&P 500 | Consumer |
| Dec. 1, 2007 to | Industrial | Technology | Staples | S&P Utilities | Health Care | Discretionary |
| May 31 2008 | Sector | Sector | Sector | Sector | Sector | Sector |
| Average daily return | 0.006% | −0.013% | −0.007% | −0.007% | −0.087% | −0.035% |
| Daily return standard | 1.40% | 1.46% | 0.88% | 1.22% | 0.99% | 1.60% |
| deviation | | | | | | |
| Annualized daily | 22.1% | 23.2% | 13.9% | 19.3% | 15.7% | 25.3% |
| return stdev | | | | | | |
| Average daily volume | 6,270,345 | 4,155,262 | 3,367,016 | 5,508,121 | 2,997,111 | 5,451,139 |
| Maximum daily volume | 16,851,973 | 10,221,870 | 12,101,591 | 14,849,773 | 10,737,892 | 28,397,807 |
| Minimum daily volume | 891,176 | 837,004 | 725,303 | 1,562,996 | 510,223 | 659,632 |
| High price | 40.12 | 27.36 | 29.18 | 43.73 | 36.52 | 34.63 |
| Low price | 34.53 | 21.77 | 26.56 | 37.34 | 30.50 | 29.48 |

| Small Cap | | | International Equities | |
|---|---|---|---|---|
| US. Equities | IShares | Powershares | IShares MSCI | IShare MSCI |
| Dec. 1, 2007 to | Russell 2000 | QQQQ | Emerging | EAFE Index |
| May 31 2008 | Index | (Nasdaq ETF) | Market Index | Fund |
| Average daily return | −0.003% | −0.007% | 0.016% | −0.032% |
| Daily return standard | 1.59% | 1.53% | 2.09% | 1.37% |
| deviation | | | | |
| Annualized daily | 25.1% | 24.2% | 33.0% | 21.7% |
| return stdev | | | | |
| Average daily volume | 83,444,732 | 151,539,958 | 19,709,376 | 12,735,225 |
| Maximum daily volume | 183,099,468 | 390,156,448 | 57,794,666 | 33,609,942 |
| Minimum daily volume | 29,867,025 | 34,499,893 | 6,101,554 | 5,156,501 |
| High price | 79.14 | 52.46 | 159.90 | 82.32 |
| Low price | 64.39 | 41.23 | 126.47 | 68.34 |

| | | Fixed Income Securities | | Commodities |
|---|---|---|---|---|
| Small Cap | International Equities | | IShares | IShares S&P |
| US. Equities | IShare MSCI | SPDR | Lehman 20 + | GSCI |
| Dec. 1, 2007 to | Japan Index | Lehman High | YR Treasury | Commodity |
| May 31 2008 | Fund | Yield Bond | Bonds | Index |
| Average daily return | −0.009% | −0.004% | −0.013% | 0.254% |
| Daily return standard | 1.58% | 0.50% | 0.89% | 1.71% |
| deviation | | | | |
| Annualized daily return | 24.9% | 7.9% | 14.1% | 27.0% |
| stdev | | | | |
| Average daily volume | 22,566,150 | 80,359 | 2,790,334 | 215,680 |
| Maximum daily volume | 119,786,233 | 1,468,617 | 11,440,965 | 778,930 |
| Minimum daily volume | 8,168,991 | 200 | 468,600 | 34,500 |
| High price | 14.23 | 46.24 | 96.07 | 70.75 |
| Low price | 11.53 | 42.40 | 88.41 | 48.90 |

| Large Cap | | | IShares DJ | | | |
|---|---|---|---|---|---|---|
| US. Equities | IShares | IShares | US | S&P 500 | S&P 500 | S&P 500 |
| Apr. 1, 2007 to | Russell 1000 | Russell 1000 | Transportation | Materials | Energy | Financial |
| May 31 2008 | Value Index | Growth Index | Average | Sector | Sector | Sector |
| Average | 0.00% | 9.58% | 0.00% | 0.00% | 7.41% | 0.00% |
| Minimum | 0.00% | 3.04% | 0.00% | 0.00% | 5.26% | 0.00% |
| Maximum | 0.00% | 15.62% | 0.00% | 0.00% | 11.87 | 0.00% |

| Large Cap | | | S&P 500 | | | S&P 500 |
|---|---|---|---|---|---|---|
| US. Equities | S&P 500 | S&P 500 | Consumer | | S&P 500 | Consumer |
| Apr. 1, 2007 to | Industrial | Technology | Staples | S&P Utilities | Health Care | Discretionary |
| May 31 2008 | Sector | Sector | Sector | Sector | Sector | Sector |
| Average | 0.00% | 0.00% | 0.00% | 0.00% | 0.00% | 0.00% |
| Minimum | 0.00% | 0.00% | 0.00% | 0.00% | 0.00% | 0.00% |
| Maximum | 0.00% | 0.00% | 0.00% | 0.00% | 0.00% | 0.00% |

| | | | | | | Fixed Income Securities | | Commodities |
|---|---|---|---|---|---|---|---|---|
| Small Cap | | | International Equities | | | | IShares | IShares S&P |
| US. Equities | IShares | Powershares | IShares MSCI | IShare MSCI | IShare MSCI | SPDR | Lehman 20 + | GSCI |
| Dec. 1, 2007 to | Russell 2000 | QQQQ | Emerging | EAFE Index | Japan Index | Lehman High | YR Treasury | Commodity |
| May 31 2008 | Index | (Nasdaq ETF) | Market Index | Fund | Fund | Yield Bond | Bonds | Index |
| Average | 18.18% | 1.407% | 19.593% | 0.000% | 12.389% | 0.000% | 0.000% | 0.000% |
| Minimum | 5.60% | −5.354% | 13.313% | 0.000% | 8.515% | 0.000% | 0.000% | 0.000% |
| Maximum | 41.13% | 8.140% | 28.172% | 0.000% | 16.767% | 0.000% | 0.000% | 0.000% |
| Cash | | | | | | | | |
| Dec. 1, 2007 to | Cash | | | | | | | |
| May 31, 2008 | | | | | | | | |
| Average | 31.43% | | | | | | | |
| Minimum | 14.11% | | | | | | | |
| Maximum | 40.39% | | | | | | | |

In the embodiment shown in FIG. 2, selecting the set of asset classes comprises collecting return and volume data on a plurality of ETFs or other assets, such as Exchange Traded Notes and futures contracts. Step 215, in this embodiment, further comprises selecting from the plurality of ETFs or other assets, the ETFs or other assets having at least 4 years of data, an average daily volume during the most recent month of at least 100,000 shares, a per-share price of at least $10, and where the dollar value of the average daily volume is greater than 20% of the assets under management. In some embodiments of the present invention, the method may return to step 215 on a periodic basis. For example, in one embodiment of the present invention, step 215 may be repeated quarterly or semi-annually to ensure assets included within the portfolio meet the requirements for inclusion. Additionally, by periodically revisiting the asset selection, new assets may be included, such as assets that had previously not had a sufficiently long period of historic data.

In step 220, the processor 120 selects factors to be used to optimize the weight of one or more assets in the portfolio. For example, academic research has shown that certain economic variables may be able to predict relative performance of certain asset classes. The factors selected by the processor 120 in step 220 are usually non-traded factors, such as market volatility, credit risk premium, slope of the term structure, level of short-term rate, and/or others. Hedge fund managers may use some of these economic variables in designing their investment strategies. Therefore, the same economic variables may be useful in the anticipating changes in optimal weights of each asset class in some embodiments of the present invention.

In the embodiment shown in FIG. 2, the processor 120 identifies candidate factors by analyzing data relating to previous academic and industry research on predictability of returns on equity and fixed income investments. For example, in one embodiment, the processor 120 may use out-of-sample forecasting power of candidate factors using multivariate regression models to determine the predictive power of candidate variables. Thus, the processor 120 can identify candidate factors that have been proven to be useful in anticipating relative performance of various asset classes. After a group of candidate factors have been identified, the processor 120 tests them to determine if their predictive power can be determined. For example, in one embodiment, the processor 120 uses out-of-sample forecasting power of candidate factors using multivariate regression models to estimate the predictive power of candidate factors. Candidate factors that have significant predictive power may be considered for use in optimizing the portfolio. Finally, each of the candidate factors is analyzed in more detail in step 225.

In step 225, after a set of candidate factors has been identified, the processor 120 employs a stepwise procedure to select the asset classes for a portfolio model. The processor 120 begins by adjusting the net returns on the benchmark for fees to estimate the gross return. To do so in this embodiment, define hₜ as the ratio of high watermark to the current Net Asset Value (NAV), where the high water mark is defined as the previous highest value of the NAV. Next, if the current period's return net of management fee is greater than (hₜ−1), then it is assumed that the manager will collect performance fee. In the embodiment shown in FIG. 2, the processor 120 calculates the estimated gross return for the benchmark using the following formula:

rₜ=[rₙₜ−(hₜ−1)inc]/(1−inc)+mgt

In the formula above, rₙₜ is the net of fees return, inc is the per month performance fee, and mgt is the per month management fee. After the processor 120 calculates the estimated gross return, it is corrected for the presence of autocorrelation. In the embodiment shown in FIG. 2, variable ρ is used to represent the estimated value of the autocorrelation, and the “unsmoothed” return is calculated by the following formula:

$${r}_{t}^{u} = \frac{{r}_{t} - ρ \times {r}_{t - 1}}{1 - ρ}$$

After calculating the unsmoothed return, the processor 120 employs stepwise regression to identify weighting factors.

Stepwise regression is a systematic method for adding and removing terms from a multi-linear model based on their statistical significance in a regression. The processor 120 begins with an initial model and then compares the explanatory power of incrementally larger and smaller models. At each step, the processor 120 computes the p-value of an F-statistic to test models with and without a potential term. If a term is not currently in the model, the null hypothesis is that the term would have a zero coefficient if added to the model. If there is sufficient evidence to reject the null hypothesis, the term is added to the model. Conversely, if a term is currently in the model, the null hypothesis is that the term has a zero coefficient. If there is insufficient evidence to reject the null hypothesis, the term is removed from the model.

To apply stepwise regression to the candidate factors, in the embodiment shown in FIG. 2, the processor 120 uses a GARCH variance-covariance matrix to fit an initial model using the most important factor. The processor 120 then uses a Bayesian Information Criterion (BIC) to test whether another factor should be added. If additional factors are added, the GARCH analysis and BIC are re-performed until a model with the lowest BIC is selected. In addition, some embodiments may require a minimum number of assets be included in the portfolio to ensure that the portfolio is well-diversified. In some embodiments, a maximum number of assets may be constrained.

In the embodiment shown in FIG. 2, the BIC is determined according to the following expression:

$$BIC = n \times ln ( \frac{RSS}{n} ) + k \times ln ( n )$$

Where n is the number of observations on assets, k is the number of assets selected by the model to be included in the portfolio and RSS is the sum of squared tracking errors of the current portfolio. Starting with one asset, k=1, additional assets are added until the lowest value of BIC is obtained. It is required that the final value of k be greater than a minimum value and less than a maximum value. In the embodiment shown in FIG. 2, the minimum value is 5 and the maximum value is 10; however, other appropriate values may be used based on the value of the assets under management. For example, if the value of the assets under management increases the minimum and/or maximum values increase as well.

In another embodiment, to perform the stepwise regression, the processor 120 performs the following three steps. In the first step, the processor 120 fits the initial model. In the second step, if any terms not in the model have p-values less than an entrance tolerance, the processor 120 adds the term with the smallest p-value to the model and repeats the second step. For example, a term that is unlikely to have a zero coefficient if added to the model may be added to the model in this step. Finally, in the third step, if any terms in the model have p-values greater than an exit tolerance, the processor 120 removes the term with the largest p-value and returns to the second step. For example, if it is unlikely that the hypothesis of zero-coefficient can be rejected for a term, it should be removed. If no terms have p-values greater than the exit tolerance, the procedure is completed. In some embodiments, a restriction may be imposed on the stepwise procedure that may ensure a well-diversified portfolio. Such a restriction may be to adjust the p-value until the number of assets selected is at least as large as a minimum number of assets to be included in the portfolio.

In step 230, the processor 120 performs a GARCH analysis to estimate the variance-covariance of asset returns, the variance of the benchmark, the covariance vector of assets returns and the benchmark, and the expected return on an asset. A GARCH analysis is a generalized autoregressive conditional heteroscedasticity analysis, a technique that can be used to model the serial dependence of volatility. Any suitable GARCH model may be used in different embodiments of the present invention, but in the embodiment shown in FIG. 2, the GARCH model comprises the following form:

mₜ=a₁mₜ₋₁+(1−a₁)rₜ

yₜ=rₜ−mₜ

sₜ=a₂sₜ₋₁+(1−a₂)yₜ×y′ₜ

In the model shown above, a₁ for i=1,2 are parameters of the model, mₜ is the estimated mean, yₜ is unexpected return, and sₜ is the variance-covariance matrix. The processor 120 estimates two parameters aᵢ by minimizing the mean squared error of the forecast variables. The forecast variables refer to the estimated values of variances and covariances and the errors refer to the difference between these estimated values and realized values of variances and covariances. After the processor 120 applies the GARCH model, a shrinkage approach is used that may improve the robustness of the estimated variance-covariance matrix using the model:

Λₜ=λ× s̅ₜ+(1−λ)sₜ

In the model shown above, s̅ₜ is the variance-covariance matrix obtained from sₜ where all off-diagonal correlations are assumed to be equal to the average off-diagonal correlations. After completing the GARCH analysis, the method moves to step 160.

In step 235, the processor 120 constructs the portfolio using an optimization procedure. In the embodiment shown in FIG. 2, the processor 120 performs a classic mean-variance optimization. By employing the conditional variance-covariance matrices estimated above, the embodiment solves the following estimation, where the vector of asset weights is denoted by wₜ:

$${min}_{w} - {α}_{2} {m}_{t} \times {w}_{t}^{′} + ( 1 - {α}_{2} ) ( \begin{matrix}{α}_{1} \times ⌊ {w}_{t}^{′} \times {\sum }_{t} \times {w}_{t}^{′} - 2 {w}_{t}^{′} {Δ}_{t} + {σ}_{t}^{2} ⌋ + \\ ( 1 - {α}_{1} ) ⌊ {w}_{t}^{′} \times {\sum }_{t} \times {w}_{t}^{′} ⌋\end{matrix} )$$

In this embodiment, Σₜ is the variance-covariance of asset returns, Δₜ is the covariance vector of asset returns with the Benchmark and σₜ² is the variance of the benchmark. Further, the parameter α₂ determines the weight that is assigned to the presence of momentum in asset returns. If its value is set equal to zero, then momentum is ignored. The parameter α₁ determines the weight that is given to minimizing the tracking error. If its value is less than one, then optimization will be given extra weight to minimizing the volatility of the portfolio.

In step 240, the processor 120 purchases assets corresponding to the portfolio. For example, in one embodiment the processor 120 may cause the interface device to transmit a signal over the network 180 to cause an asset to be sold, or to cause an asset to be purchased. In such an embodiment, the processor 120 may provide investment account information and payment information, as well as an instruction to buy or sell a specified asset in a specified quantity.

In step 245, the processor 120 adjusts the portfolio's leverage based at least in part on market volatility. For example, the volatility of the market may be assessed daily. To monitor market volatility, the processor 120 follows a procedure based on the percentage of the portfolio that is to be invested in cash. In one embodiment, the portfolio is adjusted such that the expected volatility of the portfolio remains within a pre-specified band. In such an embodiment, the lower limit of the volatility band is represented by σ_{L}, while the upper limit of the volatility band is represented by σ_{U}. To determine the percentage of the portfolio that is to be invested in cash, the following expression that corresponds to the optimal weight determined in step 235 may be used:

$${w}_{0 t} = 1 - {\sum }_{i = 1}^{p} {w}_{it}$$

The processor 120 further considers the percentage of the portfolio to be invested in all other risky assets, represented by the following expression:

$${\sum }_{i = 1}^{p} {w}_{it}$$

The processor 120 estimates volatility of the actual portfolio during a previous period in one embodiment. For example, if σ_{P} denotes the value of the estimated volatility, and if the estimated volatility is less than σ_{L}, then all weights, wᵢₜ, are multiplied by

$$\frac{{σ}_{L}}{{σ}_{P}}$$

In such an embodiment, if the estimated volatility is greater than σ_{U}, then all weights, wᵢₜ are multiplied by:

$$\frac{{σ}_{U}}{{σ}_{P}}$$

Such an embodiment may help ensure that the portfolio's volatility remains within the pre-specified band.

In one embodiment, the processor 120 also uses a risk overlay approach to increase or decrease the portfolio's leverage. In such an embodiment, an exponentially-smoothing approach is used to estimate the mean of a risk factor, such as VIX. Given an estimated value of the exponentially-smoothed mean, the weighting factors may be adjusted to help ensure that the portfolio's volatility remains within the specified band.

The processor 120 calculates the appropriate final weight of each asset in the portfolio:

$$m {vix}_{t} = η \times m {vix}_{t - 1} + ( 1 - η ) {VIX}_{t}$$

$${K}_{t} = max ( min ( \frac{m {vix}_{t}}{{VIX}_{t}} , Min L ) , Max L )$$

$${v}_{it} = {K}_{t} \times {w}_{it}$$

$${v}_{0 t} = 1 - {K}_{t} {\sum }_{i = 1}^{p} {w}_{it}$$

In the embodiment shown above, vᵢₜ denotes the final weight of asset i in the portfolio. This expression indicates that if the current level of the Implied Volatility Index, VIX, is higher than the average level of VIX, denoted by mvixₜ, then the portfolio will be de-levered to reduce market exposure. On the other hand, if the current value of VIX is relatively low, the fund's leverage may be increased subject to the constraint that leverage cannot exceed MaxL. Further, the minimum amount of leverage is limited by MinL. In the embodiment shown above, MaxL=1.15 and MinL=0.85, though in some embodiments, other minimum and maximum values may be used.

In step 180, the processor 120 monitors the asset allocation of the portfolio on a periodic basis and adjusts the portfolio based on changes in predictive factors. While, in the embodiment shown in FIG. 2, the performance of the portfolio relative to the benchmark is monitored on a monthly basis, in some embodiments, the processor 120 may monitor the portfolio's asset allocation on a daily basis. As changes in predictive factors occur, the optimal allocation weight for each asset in the portfolio may change as well. Further, the value of VIX, described above, may change on a daily basis as well. As these values change, it may affect the optimal asset allocation within the portfolio. However, it may not be preferable to change the asset allocation in some cases. In the embodiment shown in FIG. 2, assets are traded into or out of the portfolio if the weights of the asset allocations change significantly against the previous allocation. For example, in this embodiment, the positions will only be adjusted when the average of the new optimal weights, given by vᵢₜ*, are different weights by more than q:

$${ω}_{it} = \{ \begin{matrix}{v}_{it - 1} & if \frac{1}{N} {\sum }_{i = 1}^{N} \vert {v}_{it}^{*} - {v}_{it - 1} \vert \leq q \\ {v}_{it}^{*} & if \frac{1}{N} {\sum }_{i = 1}^{N} \vert {v}_{it}^{*} - {v}_{it - 1} \vert > q\end{matrix}$$

As noted above, the processor 120 may continue to perform steps 245 and 250 on a periodic basis to maintain appropriate leverage ratios and asset allocation ratios. Additionally, the method may periodically return to step 215 to re-evaluate the appropriate assets to include within the portfolio.

While the methods and systems herein are described in terms of software executing on various machines, the methods and systems may also be implemented as specifically-configured hardware, such a field-programmable gate array (FPGA) specifically to execute the various methods. For example, referring again to FIGS. 1 and 2, embodiments can be implemented in digital electronic circuitry, or in computer hardware, firmware, software, or in combination of them. In one embodiment, a computer may comprise a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

### General

The foregoing description of some embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

That which is claimed is:

1. A computer-implemented method comprising:
receiving information describing a plurality of funds;
receiving a selection of a benchmark for an investment portfolio;
identifying a candidate set of assets for the investment portfolio, the candidate set of investments comprising a plurality of asset classes;
identifying a set of candidate weighting factors to associate with at least one of the plurality of asset classes;
selecting at least one weighting factor from the set of candidate weighting factors;
selecting at least one asset class from the plurality of asset classes based on a stepwise procedure and associating the at least one weighting factor with at least one asset class;
determining a weight value of the at least one weighting factor;
estimating, based on a GARCH analysis, a variance/covariance of asset returns, a variance of the benchmark, a covariance vector of asset returns, and an expected return on an asset;
constructing the investment portfolio from at least one of the candidate sets of assets and based on the at least one weighting factor; and
purchasing assets corresponding to the investment portfolio.

2. The computer-implemented method of claim 1, further comprising adjusting a leverage of the investment portfolio based at least in part on market volatility.

3. The computer-implemented method of claim 1, wherein at least one of the asset classes corresponds to a commodity.

4. The computer-implemented method of claim 1, wherein the plurality of funds comprises at least one of a hedge fund, an uninvestable index, or an investable index.

5. The computer-implemented method of claim 1, further comprising monitoring the investment portfolio based on the at least one weighting factor.

6. The computer-implemented method of claim 2, wherein monitoring the investment portfolio comprises trading assets into or out of the investment portfolio based on the at least one weighting factor.

7. The computer-implemented method of claim 2, wherein monitoring the investment portfolio comprises adjusting the weight value.

8. The computer-implemented method of claim 1, further comprising monitoring the investment portfolio based on the at least one weighting factor.

9. The computer-implemented method of claim 1, wherein the benchmark comprises a desired return for the investment portfolio based on at least one hedge fund manager.

10. The computer-implemented method of claim 3, wherein the benchmark is based on a publicly available uninvestable index.

11. The computer-implemented method of claim 1, further comprising filtering data associated with one or more hedge fund managers.

12. The computer-implemented method of claim 5, wherein filtering data associated with one or more hedge fund managers comprises determining a strategy employed by each of the one or more hedge fund managers.

13. The computer-implemented method of claim 1, wherein the asset classes comprise at least one of an Exchange Traded Fund, an Exchange Traded Note, or a futures contract.

14. The computer-implemented method of claim 1, wherein the at least one candidate weighting factor comprises at least one of market volatility, credit risk premium, slog of the term structure, or level of short-term rate.

15. The computer-implemented method of claim 1, wherein adjusting the leverage is performed daily.

16. A computer-readable medium comprising program code for performing a computer-implemented method, the program code comprising:
program code for receiving information describing a plurality of funds;
program code for receiving a selection of a benchmark for an investment portfolio;
program code for identifying a candidate set of assets for the investment portfolio, the candidate set of investments comprising a plurality of asset classes;
program code for identifying a set of candidate weighting factors to associate with at least one of the plurality of asset classes;
program code for selecting at least one weighting factor from the set of candidate weighting factors;
program code for selecting at least one asset class from the plurality of asset classes based on a stepwise procedure and associating the at least one weighting factor with at least one asset class;
program code for determining a weight value of the at least one weighting factor;
program code for estimating, based on a GARCH analysis, a variance/covariance of asset returns, a variance of the benchmark, a covariance vector of asset returns, and an expected return on an asset;
program code for constructing the investment portfolio from at least one of the candidate sets of assets and based on the at least one weighting factor; and
program code for purchasing assets corresponding to the investment portfolio.

17. A system, comprising:
an interface device for receiving information describing a plurality of funds;
a memory; and
a processor in communication with the memory and the interface device, the processor configured to:
receive information describing a plurality of funds
receive a selection of a benchmark for an investment portfolio;
identify a candidate set of assets for the investment portfolio, the candidate set of investments comprising a plurality of asset classes;
identify a set of candidate weighting factors to associate with at least one of the plurality of asset classes;
select at least one weighting factor from the set of candidate weighting factors;
select at least one asset class from the plurality of asset classes based on a stepwise procedure and associating the at least one weighting factor with at least one asset class
determine a weight value of the at least one weighting factor;
estimate, based on a GARCH analysis, a variance/covariance of asset returns, a variance of the benchmark, a covariance vector of asset returns, and an expected return on an asset;
construct the investment portfolio from at least one of the candidate sets of assets and based on the at least one weighting factor; and
purchase assets corresponding to the investment portfolio.
